(19) United States
(12) Patent Application Publication
(10) Pub. No.: US 2010/0258494 A1
(43) Pub. Date: Oct. 14, 2010

(54) Packing Material for a Micro-Adsorption Column for Drying and/or Purification of Dissolved Organic or Biological Analytes and Micro-Adsorption Column and use thereof

(76) Inventors: Martin Freudenschuss, Ybbs (AT); Günther Jaunecker, Tulln (AT); Rudolf Krska, Tulln (AT); Eva Maria Binder, Unterwart (AT)

Correspondence Address: JACOBSON HOLMAN PLLC, 400 SEVENTH STREET N.W., SUITE 600, WASHINGTON, DC, 20004, US

(21) Appl. No.: 11/991,787

(22) PCT Filed: Aug. 31, 2006
(86) PCT No.: PCT/AT2006/000358

§ 371 Date: Mar. 11, 2008

(30) Foreign Application Priority Data
Sep. 12, 2005 (AT) A 1498/2005

(51) Int. Cl. B01D 15/04; B01J 20/04

(52) U.S. Cl. 210/266; 252/194; 210/287

(57) ABSTRACT

The invention relates to a packing material for a micro-adsorption column for drying and/or purification of dissolved organic or biological analytes, such as toxins, antibiotics, vitamins, hormones, pesticides and similar, containing at least one drying agent which contains magnesium sulphate and at least one further drying agent selected from the group comprising aluminium oxide, calcium chloride, calcium hydride, calcium oxide, calcium sulphate, potassium hydride, silica gel, copper sulphate, magnesium oxide, magnesium perchlorate, molecular sieves, sodium hydroxide, phosphorus pentoxide, sulphuric acid on silica, phosphorus pentoxide on silica and 0.5 to 90 wt. % of a naturally-occurring or synthetic support with large internal surface such as zeolite, diatomic earths, bentonite, silicon dioxide or similar. The invention further relates to a micro-adsorption column packed with the above and use thereof.

This is a national stage of PCT/AT2006/000358, filed on Aug. 31, 2006 and published in German.

### FIELD OF THE INVENTION

The present invention relates to a packing material for a micro-adsorption column for drying and/or purifying dissolved organic or biological analytes such as toxins, antibiotics, vitamins, hormones, pesticides and the like, containing at least one desiccant, a micro-adsorption column filled with the same, and the use thereof.

### PRIOR ART

Organic or analytical chemistry frequently involves the problem that very small amounts of substances for further examinations or detection processes have to be subjected to drying and/or purification or even derivatization prior to their use in such detection processes, in order to prevent any interference with subsequent process steps or the introduction of excessive quantities of impurities and/or water into subsequent procedures, which would interfere with those procedures and render the results to be obtained with the same no longer representative.

For the purification of small amounts of dissolved substances, U.S. Pat. No. 4,895,808 and U.S. Pat. No. 5,110,558 have, for instance, proposed methods and devices for the adsorption and detection of adsorbents or analytes, which methods are based on special devices comprised of a combination of tubes, wherein the dissolved analyte is introduced into an outer tube, into which a second tube equipped with a frit is frictionally inserted, said second tube containing purifying and/or drying materials, optionally in layers. A device of this type is to ensure the purification and/or drying of organic or biological analytes to a certain extent, a substance prepurified in this manner subsequently having to be examined for the presence of specific analytes. The device and the method described in U.S. Pat. No. 4,895,808 and U.S. Pat. No. 5,110,558, respectively, however, involve the drawback that, although such a device allows for the partial purification of the analytes, it does not enable the drying and/or purification of the sample solutions to be investigated, since an efficient use of desiccant is not possible in such columns, such columns being immediately obstructed, or poorly permeable, upon contact with water-containing fluids and apparently rendering impossible any useful further purification and, in particular, subsequent derivatization frequently required of the analyte solution to be examined.

Conventional column-chromatographic analytical methods, in which analytes are applied on conditioned columns and washed out again or eluted from said columns by the aid of eluants with or without the application of pressure, involve similar problems in that it is feasible to pack such columns with the respective purifying materials, yet a useful purification and/or drying, in particular by providing a desiccant in such analytical columns, does not appear possible, because also in that case the columns would be blocked when adding water-containing solutions, which would apparently render impossible any further separation or useful elution rate of the substances to be examined.

In the past, the process control has, therefore, been chosen such that the analyte solutions to be examined in a first step are passed over special purifying materials either in micro-columns according to U.S. Pat. No. 4,895,808 or U.S. Pat. No. 5,110,558, or through conventional HPLC, LC or other preparative or analytical columns, and the purified analyte solutions eluted from the columns, or separated analyte solutions, are subsequently subjected to conventional drying either by the evaporation of the solvents or by the addition of excess amounts of desiccant to the organic solution, whereupon, for a further analysis of the substance, the latter must either be re-eluted from the desiccant or absorbed by an anhydrous solvent in order to be supplied to a subsequent analytical process. That process control for providing a usefully purified and/or dried sample is extremely time-consuming, thus constituting unnecessary procedural and time expenditures in modern analytics, which is aimed at performing rapid assays or rapid tests for harmful substances, which procedural and time expenditures bear no relation to the required speed and the purity of desired samples.

### SUMMARY OF THE INVENTION

The present invention therefore aims to provide a packing material for a micro-adsorption column for drying and/or purifying dissolved organic or biological analytes such as toxins, antibiotics, vitamins, hormones, pesticides and the like, which avoids the drawbacks of the prior art of enabling to carry out drying and/or purifying in a one-step reaction and, on the other hand, safely prevents an obstruction of the column by moisture or water contained in the solvents.

The invention further aims to provide a micro-adsorption column which enables the simultaneous drying and/or purifying of analytes dissolved in organic aqueous solvents in an extremely rapid manner without obstructing the employed adsorption column by the moisture contained in the solvent or introducing the moisture contained in the solvent into the sample to be analysed, while enabling the subsequent derivatization of the analytes to be examined without interference and additional purification steps.

To solve this object, the packing material according to the invention for a micro-adsorption column is essentially characterised in that the packing material for a micro-adsorption column contains magnesium sulphate and at least one further desiccant selected from the group comprising aluminium oxide, calcium chloride, calcium hydride, calcium oxide, calcium sulphate, potassium hydride, silica gel, copper sulphate, magnesium oxide, magnesium perchlorate, molecular sieves, sodium hydroxide, phosphorus pentoxide, sulphuric acid on silicate, phosphorus pentoxide on silicate, as well as 0.5 to 90 wt. % of a naturally occurring or synthetic carrier with a large internal surface area, such as zeolites, diatomaceous earths, bentonite, silicon dioxide or the like. By using, as a packing material for a micro-adsorption column, a mixture of magnesium sulphate and at least one further desiccant, preferably at least two desiccants, as well as 0.5 to 90 wt. % of a naturally occurring or synthetic carrier with a large internal surface area, it is feasible, by distributing the desiccant on the naturally occurring or synthetic carrier with a large internal surface area, to configure the drying capacity of the desiccant in such a manner that the whole surface area of the desiccant will be available to the reaction with the moisture contained in the solution as opposed to the prior art, where the surface area of the desiccant would react and the remaining desiccant would not be reached by the moisture contained in the solution, since the surface area has already formed a dense layer reacted with moisture, thus preventing the remaining desiccant from entering the reaction. Moreover, the naturally occurring or synthetic carrier with a large internal surface will react as an adsorbent for the most diverse organic or biological analyte being contained in the solution such that, in addition to the drying procedure already constituting a purification of the solution, a further purification going beyond the former will be achieved by the removal of harmful substances attached to the carrier with a large internal surface area.

The use of a column packing material containing a mixture of different desiccants in addition to the carrier will ensure a particularly efficient drying of the dissolved organic or biological analytes, while such a column packing material will, at the same time, also enable, for instance, the purification of a slurry, in particular if higher amounts of a natural or synthetic carrier with a large internal surface area are contained, since solid particles contained in such a slurry will be reliably retained by the carrier having a large internal surface area.

According to a further development of the invention, the packing material for a micro-adsorption column is devised such that it contains 5 to 70 wt. % carrier. By using a wide spectrum of the carrier with a large internal surface area, the drying and purification behaviour of the column packing material can be controlled accordingly, column packing materials containing high amounts of a carrier with a large internal surface area exhibiting markedly improved purification actions in addition to their drying actions, and micro-adsorption column packing materials having only low portions of a carrier with a large internal surface area, in particular, exhibiting strongly enhanced drying effects over the use of pure desiccants alone, which is again attributed to the previously described break-up effect of the desiccant.

Particularly efficient drying at the simultaneous purification of the dissolved organic or biological analytes will be achieved with a packing material for a micro-adsorption column, which is comprised of 0.5 to 90 wt. % carrier, 20 to 60 wt. % magnesium sulphate, 20 to 60 wt. % potassium carbonate and 10 to 35 wt. % calcium chloride. Such a column packing material is able to dry and purify dissolved organic or biological analytes even containing higher amounts of water in the solution, e.g. from 20 to 30% H₂O, without causing a blockage or obstruction of the column by clumped desiccant reacted with water.

In order to ensure an even more complete drying and/or purification of the dissolved organic or biological analytes and, in particular, enable the subsequent derivatization of the analyte without any further purification or drying, the packing material according to the invention for a micro-adsorption column is further developed such that the column packing material additionally contains at least one adsorbent or detergent selected from the group comprising cyclic, linear or branched C₈ or C₁₈ hydrocarbons substituted with phenyl, cyclohexyl, butyl, ethyl, methyl, cyanopropyl, diol, carboxylate, benzenesulfoxylate, aminopropyl, primary, secondary, tertiary or quaternary amino residues or diethylamine; neutral, acidic or basic aluminium oxide, ion exchangers, silica gel, active carbon or magnesium silicate.

Since the column packing material additionally contains at least one adsorbent or detergent, the dissolved organic or biological sample or analyte, in addition to an efficient drying or adsorption of impurities, can also be chemically purified so as to simultaneously eliminate, by using a single column packing material, any substances interfering with a subsequent detection or analysis and provide a packing material for a micro-adsorption column, that enables a particularly rapid and efficient purification and/or drying or even derivatization for the subsequent detection of the dissolved analyte.

For a particularly efficient use of the individual substances contained in the packing material for a micro-adsorption column, the column packing material is used in the form of layers, as in accordance with a preferred further development of the invention. By such a use in the form of layers, it is, for instance, feasible in a column to initially provide a desiccant layer and then an adsorbent or detergent layer, and vice versa. Such a process control enables the individual substances contained in the respective layers to be taken into account, for instance, with a view to passing an analyte dissolved in an organic solvent through substances present in a detergent-containing layer and requiring OH groups or slight amounts of water for an efficient action, said solvent also containing water, and only subsequently effect drying, and, on the other hand, in the event of substances that do not require any water for their action, initially effecting drying of the organic solvent in which the analyte is dissolved and only then carry out a further purification from interfering substances. Such a column packing material provides a particularly efficient and complete purification and drying of the analyte dissolved in an organic solvent, or the biological substance, so as to enable the subsequent derivatization with water-sensitive reagents without any further purification.

According to a further development of the present invention, the packing material for a micro-adsorption column is devised such that the column packing material contains at least one purification or adsorption layer comprised of a mixture of 0.5 to 90 wt. % carrier, optionally silica gel, and at least one cyclic, linear or branched C₈ or C₁₈ hydrocarbon substituted with phenyl, cyclohexyl, butyl, ethyl, methyl, cyanopropyl, diol, carboxylate, benzenesulfoxylate, aminopropyl, primary, secondary, tertiary or quaternary amino residues or diethylamine, as well as at least one desiccant layer comprised of 0.5 to 90 wt. % carrier, the balance being desiccant. The use of a column packing material in layer form containing, inter alia, substituted or unsubstituted C₈ or C₁₈ hydrocarbons, so-called “reversed phase” materials, as well as a carrier comprised of a synthetic or naturally occurring substance with a large internal surface area as well as a further layer containing an identical or analogous carrier of a synthetic or natural substance with a large internal surface area as well as a desiccant will ensure the efficient and complete purification and drying of analytes dissolved in organic solvents. The separation of noxious substances or substances interfering with analyses will be readily and efficiently feasible, particularly by using the so-called reversed phase materials, as is known per se, whereby further substances such as, in particular, solids will attach to the carrier and, as a result, all of the water contained in the organic solvent will be eliminated by passing the solution through the desiccant layer likewise containing a carrier. After the passage of a sample through such a column packing material, a purified analyte will be obtained, which can be immediately subjected to a detection or analysis.

According to a further development, the packing material for a micro-adsorption column is devised such that the column packing material contains at least one purification or adsorption layer comprised of a mixture of 0.5 to 90 wt. % and, in particular, 5 to 87 wt. % carrier, in particular a diatomaceous earth, 10 to 80 wt. % and, in particular, 25 to 50 wt. % aluminium oxide, 2 to 70 wt. % and, in particular, 8 to 35 wt. % ion exchanger, 10 to 95 and, in particular, 12 to 70 wt. % active carbon as well as 3 to 65 and, in particular, 10 to 40 wt. % of at least one cyclic, linear or branched C₈ or C₁₈ hydrocarbon substituted with phenyl, cyclohexyl, butyl, ethyl, methyl, cyanopropyl, diol, carboxylate, benzenesulfoxylate, aminopropyl, primary, secondary, tertiary or quaternary amino residues or diethylamine, as well as at least one desiccant layer comprised of 0.5 to 90 wt. % carrier, the balance being desiccant. Such a column packing material will not only ensure the complete purification and drying of the dissolved analyte or biological substance within an extremely short period of time, since all of the substances contained in the layers of the column packing material contribute to such purification and drying, acting simultaneously or in parallel, so as to ensure a particularly rapid and efficient purification and/or drying.

Moreover, such a packing material for a micro-adsorption column cannot only be envisaged for the purification and drying of the analyte employed, but, for instance, can also be used for the derivatization of samples with water-sensitive reagents prior to their analyses, in particular any biological samples such as foods, feeds, grains, biological samples such as blood, urine, tissues, plant materials, and the noxious substances can, for instance, be directly detected and/or quantified by GC/MS or GC/ECD.

The column packing material can also be applied for chemical quick-tests, since solid impurities will be reliably eluted or separated on the column packing material, as already pointed out above.

According to a further development of the invention, a micro-adsorption column for drying and/or purifying dissolved organic or biological analytes is, moreover, provided, which column is devised such that said column is packed with magnesium sulphate and at least one further desiccant selected from the group comprising aluminium oxide, calcium chloride, calcium hydride, calcium oxide, calcium sulphate, potassium hydride, silica gel, copper sulphate, magnesium oxide, magnesium perchlorate, molecular sieves, sodium hydroxide, phosphorus pentoxide, sulphuric acid on silicate, phosphorus pentoxide on silicate, as well as 0.5 to 90 wt. % of a naturally occurring or synthetic carrier with a large internal surface area, such as zeolite, diatomaceous earths, bentonite, silicon dioxide or the like. A thus-packed column allows for the adsorption of suspended matter and also the separation of adsorbable dissolved impurities on the carrier and, at the same time, the complete elimination of the water contained in the solvent, thus enabling the analyte to be directly and immediately subjected to an analysis, which would, in particular, be disturbed by water.

According to a further development, the micro-adsorption column is packed with 5 to 70 wt. % carrier, thus being able to selectively take into account the special conditions of a sample and, in particular, the water content of the sample and the content of impurities of the sample.

By packing the column with at least two layers, as in correspondence with a further development of the invention, the adsorption column may either comprise different drying stages containing, for instance, more or less carrier with a large internal surface area, or more or less desiccant, or layers containing different desiccants or different carriers, or even be used as an adsorption column containing an additional detergent or adsorbent besides a desiccant.

In order to prevent the column from becoming inhomogeneous, or individual layers from being separated, or holes from forming in the packed column, by the sample and, in particular, liquid sample containing the analyte or biological substance being pressed through the column, the invention is further developed such that the column, on its feed end, outflow end and optionally between the layers, is each equipped with a filter layer selected from a frit, filter paper, membrane or diaphragm. Such a micro-adsorption column will, furthermore, enable the separation of coarse, solid impurities or undissolved substance particles prior to the inflow into the micro-adsorption column, of the analyte sample to be examined while, at the same time, preventing the discharge of entrained detergent and/or desiccant particles into the sample to be examined, thus providing a micro-adsorption column operating in a particularly clean and efficient manner.

According to a further development of the invention, the micro-adsorption column is characterised in that at least one of the layers is a desiccant-containing layer and at least one of the layers is a detergent- or adsorbent-containing layer, the detergent or adsorbent being selected from the group comprising cyclic, linear or branched C₈ or C₁₈ hydrocarbons substituted with phenyl, cyclohexyl, butyl, ethyl, methyl, cyanopropyl, diol, carboxylate, benzenesulfoxylate, aminopropyl, primary, secondary, tertiary or quaternary amino residues or diethylamine; neutral, acidic or basic aluminium oxide, ion exchangers, silica gel, active carbon or magnesium silicate. By the adsorption column being packed with at least one desiccant-containing layer and an adsorbent-containing layer, as in correspondence with a further development of the invention, a particularly efficient and rapid separation, drying and purification of the sample to be analysed has become feasible, as already pointed out above, such an adsorption column thus being suitable for a one-step purification and, in particular, derivatization and/or rapid analysis of analytes or biological substances to be examined.

By the micro-adsorption column being packed, from its feed end to its outflow end, with a first purification or adsorbent layer containing 0.5 to 90 wt. % carrier, silica gel as well as, optionally, aluminium oxide and/or an ion exchanger, a first desiccant layer comprised of 0.5 to 90 wt. % carrier, magnesium sulphate as well as one or several further desiccants selected from the group of aluminium oxide, calcium oxide, calcium sulphate, potassium hydride, silica gel, copper sulphate, magnesium oxide, molecular sieves, sodium hydroxide, phosphorus pentoxide, sulphuric acid on silicate, phosphorus pentoxide on silicate, a second purification or adsorbent layer containing 0.5 to 90 wt. % carrier, as well as at least one cyclic, linear or branched, and substituted C₈ or C₁₈ hydrocarbon, as well as optionally active carbon, and a second desiccant layer containing 0.5 to 90 wt. % carrier and a desiccant selected from calcium chloride, potassium carbonate, magnesium sulphate as well as optionally one or several further desiccants selected from the group comprising calcium hydride, calcium oxide, calcium sulphate, potassium hydride, silica gel, magnesium oxide, magnesium perchlorate, sodium hydroxide, phosphorus pentoxide, sulphuric acid on silicate, phosphorus pentoxide on silicate, as in correspondence with a further development of the invention, specific particularities of analytes to be examined or specific reactivities of the individual substances contained in such a column can be taken into account so as to achieve an even more efficient and rapid purification and drying of the sample without requiring any additional time.

By initially passing the sample through a detergent requiring a water content for its purification, and subsequently effecting first drying before performing a further purification with a detergent not necessarily requiring an aqueous solution of the analyte for its mode of action, and then reacting the same with an extremely efficient desiccant for separating residual moisture, as it is done with such an adsorption column, all of the interfering impurities and substances interfering with an analysis as well as the water can be eliminated in a so-called one-step reaction, whereby, as already pointed out above, even slurries and the like can be used without blocking or obstructing the column material, and derivatizations with extremely water-sensitive reagents can be performed immediately thereupon without any further prepurifying and/or drying.

Finally, the present invention aims at the use of a column packing material or micro-adsorption column for drying and/or purifying dissolved organic or biological analytes such as toxins, antibiotics, vitamins, hormones, pesticides and the like, wherein, for such a use, the column packing material or column is used for drying and/or purifying an aqueous organic solution having a water content of up to 30 wt. % of the organic or biological analytes. Such a packing material for a micro-adsorption column, in particular by such a use, will enable the safe and reliable separation of extremely high water contents from organic solvents such that subsequent analytical steps such as GC, MS, GC/MS, GC/ECD and the like will be safely and reliably feasible immediately after the purification and/or drying of the analyte solution to be examined, without any interfering substances such as water and the like.

A particularly efficient use of a column packing material is characterised in that the ratio of the column packing material to the analyte solution to be treated is at least 2:1 to 1:5 and, in particular, 1.5:1 to 1:2.5. By using a ratio of column packing material to analyte solution to be treated, of at least 2:1 to 1:5 and, in particular, 1.5:1 to 1:2.5, a comparatively large amount of packing material will always be provided for a micro-adsorption column, based on the analyte solution to be treated, whereby sufficiently reactive surface areas, and also desiccants and detergents, will be made available so as to enable an extremely rapid purification, an also extremely rapid drying, of the analyte solution to be treated.

### DETAILED DESCRIPTION OF PREFERRED EMBODIMENTS

In the following, the invention will be explained in more detail by way of an example.

In this example, a plurality of different mixtures of a desiccant and a carrier with a large internal surface area as well as a plurality of mixtures comprising detergents or adsorbents and a carrier, as well as columns filled therewith were produced, which were subsequently used to purify various organic or biological agents and mycotoxins. For comparison, the same mycotoxins or biological samples were subjected to conventional purifications, and subsequent derivatizations or analyses were performed both on samples and on comparative samples in order to compare the results of the column packing material, or adsorption columns packed with the column packing material, with those of the prior art.

Desiccant mixture 1:300 mg diatomaceous earth with a large internal surface area, which is marketed by Cornay under the trade name Celite®, 500 mg zeolite, 300 mg calcium chloride

Desiccant mixture 2: 300 mg Celite®, 500 mg magnesium sulphate, 500 mg calcium carbonate, 300 mg calcium chloride

Desiccant mixture 3: 1000 mg Celite®, 500 mg silica gel, 500 mg molecular sieve, 100 mg potassium hydride, 100 mg potassium carbonate

Desiccant mixture 4: 500 mg Celite®, 100 mg sulphuric acid on silicate, 300 mg aluminium oxide, 300 mg silica gel, 500 mg molecular sieve, 100 mg calcium sulphate

Detergent mixture 1: 500 mg diatomaceous earth with a large internal surface area, which is marketed by Cornay under the trade name Celite®, 50 mg aluminium oxide, 300 mg cyclohexyloctadecane

Detergent mixture 2: 300 mg 1,3,5-triethyloctadecane, 80 mg of a basic ion exchanger, 100 mg active carbon, 500 mg diatomaceous earth, 500 mg of a mixture of different naturally occurring zeolites.

Detergent mixture 3: 300 mg 1,3,5-triethyloctadecane, 80 mg of a basic ion exchanger, 500 mg diatomaceous earth, 500 mg of a mixture of different naturally occurring zeolites.

Columns were each filled to contain 1.5 g of one of the four desiccant mixtures, another column was filled with 1.5 g desiccant mixture 1 and 1.5 g desiccant mixture 3. Furthermore, five columns were each filled with 1.5 g detergent mixture 1 and 1.5 g desiccant mixture 1, 1.5 g detergent mixture 2 and 1.5 g desiccant mixture 2, 1.5 g detergent mixture 3 and 1.5 g desiccant mixture 3, 1.5 g detergent mixture 1 and 1.5 g desiccant mixture 4 as well as 1.5 g detergent mixture 3 and 1.5 g desiccant mixture 2. Finally, a tube was filled with 1 g detergent mixture 1 and 1 g desiccant mixture 2, 1 g detergent mixture 2 and 1 g desiccant mixture 3.

By the aid of the above tubes, 5 ml of an organic solution containing B-trichothecene were each purified and dried, and that solution was subsequently investigated by means of GC-ECD (gas chromatography) using an Electron Cepture Detector. The used eluate was recovered by the extraction of 25 g of a ground cereal with 100 ml acetonitrile/water and subsequent filtration through a fluted filter. 5 ml of this eluate were filled into a purification or adsorption tube according to U.S. Pat. No. 4,895,808, and a second, internal tube filled with the detergents and desiccants indicated above was inserted under pressure into each of the samples such that 3 ml of purified eluate could be recovered in the internal tube containing the detergent and/or desiccant.

From this eluate, stock solutions of the respective reference substances are prepared with the commercially available reference substance (in pure acetonitrile) in 20 ml measuring flasks, at concentrations of about 2.5 μg/ml. The stock solutions of the reference substances were each diluted to a concentration of 0.5 μg/ml, and to these 1 ml of the respective standard solution was each pipetted into a 10 ml screw-cap valve, which was filled up with 4 ml acetonitrile. The vials were closed and thoroughly mixed prior to their use. After this, two standard dilution series of the standard and sample solutions to be examined were prepared, and the samples were supplemented with Tri-Sil TBT derivatization reagent (Tri-Sil TBT being a mixture of N-trimethylsilylimidazol-N,O-bis(trimethylsilyl)acetamide and trimethylsilylchloride) as well as TMS, and closed. The reaction solutions were mixed. The vials were incubated for 15 min at 40° C. in the drying cabinet and taken up with isooctane and a buffer solution. After the take-up of the organic phase with isooctane, the samples are examined in a HP 5890 Series 2 gas chromatograph, which was equipped with an autoinjector and an Electron Capture Detector (ECD) connected thereto. GC analyses of both the sample and the comparative sample revealed substances with the characteristic retention time of the DON derivative employed, and no disturbances of the present sample by impurities or water were detected. The retention times of the main components were as follows: DON: 24.72 min; 3-AcDON: 31.21 min; 15-AcDON: 33.84 min; fuseranon X: 34.87 min and nivalenol: 37.43 min.

The use of the individual mixed tubes for the analysis of B-trichothecene produced the following results:

Desiccant mixture 1: No interfering water peak was found, yet impurities in the GC analysis.

Desiccant mixture 2: No interfering water peak was found, yet impurities in the GC analysis.

Desiccant mixture 3: No interfering water peak was found, yet impurities in the GC analysis.

Tube containing two desiccants: No interfering water peak was found, yet slight impurities in the GC analysis, the detected amount of impurities having markedly decreased as against the use of but one desiccant, which is supposed to be due to the elevated content of diatomaceous earth.

Tube containing desiccant mixture 1 and desiccant mixture 3: No interfering water and hardly any interfering impurities were found.

Tube containing detergent mixture 1 and desiccant mixture 1: Neither interfering water nor any interfering impurities were found.

Tube containing detergent mixture 2 and desiccant mixture 2: No interfering water and hardly any interfering impurities were found.

Tube containing detergent mixture 3 and desiccant mixture 3: Neither interfering water nor any interfering impurities were found.

Tube containing detergent mixture 1 and desiccant mixture 2: Neither interfering water nor hardly any interfering impurities were found.

Tube containing detergent mixture 3 and desiccant mixture 2: No interfering water and hardly any interfering impurities were found.

Tube containing detergent mixture 1, desiccant mixture 2, detergent mixture 2 and desiccant mixture 3: Neither interfering water nor any interfering impurities were found, but only the substance peak was clearly recognizable in GC.

To sum up, it can be said that, in particular, column packing materials comprised of several layers, with at least one layer containing a detergent or adsorbent and one layer containing a desiccant being used, provide excellent results in the subsequent GC analysis of a derivatized product.

For comparison, an analogous sample containing B-trichothecene was purified and subsequently derivatized as described above. The purification of the sample containing the mycotoxin was performed as follows. An aqueous solution of the mycotoxin was acidified with sulphuric acid, and 5 ml thereof were extracted with acetonitrile and hexane and subsequently centrifuged. The hexane phase is separated. The acetonitrile phase is concentrated in a nitrogen flow. The acetonitrile phase is concentrated in a nitrogen flow, the concentrate is taken up in water and the pH is adjusted to 8.5 and packed on an oasis column previously equilibrated with 2 ml methanol and 2 ml water. The column is washed, the mycotoxins are extracted with methanol, the extract is dried, and the remainder is dissolved and diluted and then further derivatized as described above. Such processing according to the prior art, compared with the above-described packing material for a micro adsorption column according to the present invention, requires 10 to 20 times as much time for the processing of the mycotoxins and, apart from that, does not yield a product as pure as those obtained with the present column packing materials.

After this, the column packing materials according to the invention and, in particular, column packing materials containing two different desiccants, or column packing materials containing a layer of a detergent or adsorbent and a layer of a desiccant, as well as columns comprising several layers were used for:

### a) The Analysis of Nitrofuran Antibiotics in Fish and Meat Products

The purification of 5 ml of the extracted sample was performed using a tube containing 1.5 g detergent mixture and 1.5 g desiccant mixture.

3 ml of the purified sample were processed according to the analytics of B-trichothecene and subsequently derivatized with 2-nitrobenzaldehyde for HPLC analysis and examined on a HPLC column. The results again immediately revealed a substance peak and a peak of the comparative material, yet no interfering water amounts or impurities.

### b) The Analysis of Fluorochinolone Antibioticys in Meat Residues

The purification was carried out on 5 ml of an extracted sample containing the analyte, using a tube containing 1.5 g detergent mixture and 1.5 g desiccant mixture. 2 ml of the purified sample were subsequently directly analysed by HPLC on an Agilent 1100 HPLC-system using a Zorbax Eclipse SCB-C8 column and were subsequently quantified by the aid of a fluorescence detector. The results again immediately revealed a substance peak and a peak of the comparative material, yet no interfering water amounts or impurities.

### c) The Analysis of Nitrofuran Metabolites in Fish and Meat Products

The purification was carried out on 5 ml of a solution containing the analyte, using a tube containing 1.5 g detergent mixture and 1.5 g desiccant mixture.

2 ml of the purified sample were derivatized with 2-nitrobenzaldehyde for HPLC analysis and analysed on an Agilent 1100 HPLC-system. The separation column was a 3.5 μm Zorbax Eclipse XDB C18 column, and the detector was an MSD ion trap detector (in the positive ionic mode). The results again immediately revealed a substance peak and a peak of the comparative material, yet no interfering water amounts or impurities.

### d) The Analysis of Paraben Derivatives

The purification was carried out on 5 ml of a solution containing the analyte, using a tube containing 1.5 g detergent mixture and 1.5 g desiccant mixture.

2 ml of the purified sample were subsequently directly analysed on an Agilent 1100 HPLC-system using UV detection. The results again immediately revealed a substance peak and a peak of the comparative material, yet no interfering water amounts or impurities.

### e) The Analysis of Sulfonamides in Meat

The purification was carried out on 5 ml of a solution containing the analyte, using a tube containing 1.5 g detergent mixture and 1.5 g desiccant mixture.

2 ml of the purified sample were directly analysed on an Agilent 1100 HPLC-system, i.e. separated by a 5 μm Zorbax Eclipse XDB C8 column and MS-detected by APCI (atmospheric pressure chemical ionization). The results again immediately revealed a substance peak and a peak of the comparative material, yet no interfering water amounts or impurities.

### f) The Analysis of Salbutamol in Urine

The purification was carried out on 5 ml of a solution containing the analyte, using a tube containing 1.5 g detergent mixture and 1.5 g desiccant mixture.

1 ml of the purified sample was derivatized with N-methyl-N-trimethylsilyltrifluoroacetamide and analysed by GC/MS. In doing so, a capillary column (length 30 m, internal diameter 0.25 mm, layer thickness 0.25 mm) was used for the same separation. The results again immediately revealed a substance peak and a peak of the comparative material, yet no interfering water amounts or impurities.

### g) The Analysis of Doping Agents in Urine

The urine sample was neutralised and treated with 13-glucoronidase (2 h, 50° C.) and subsequently diluted 1:4 with acetonitrile. The purification was performed on 5 ml of a solution containing the analyte, using a tube containing 1.5 g detergent mixture and 1.5 g desiccant mixture. The analytical determination was carried by 1100 HPLC MS (electrospray modus), with a 3.5 μm Agilent Zorbax Eclipse XDB C18 column having been used for the separation. The results again immediately revealed a substance peak and a peak of the comparative material, yet no interfering water amounts or impurities.

### h) The Analysis of Pesticides in Fruits, Vegetables or Fruit Juice

An aqueous extract or extract mixture of the sample with acetonitrile/water is purified using a tube containing 1.5 g detergent mixture and 1.5 g desiccant mixture.

The purified sample is directly injected into a LVI-GC MS (Large volume injection gas chromatograph with mass detector): Agilent 6890 GC with Quadrupol mass detector, autoinjector and chromatographic separation using a DB-5MS column. The results of the analysis again immediately revealed a substance peak and a peak of the comparative material, yet no interfering water amounts or impurities.

This method enables the detection of the following pesticides: 2-phenylphenol, Amitraz, bifenthrin, bromopropylate, bromopropylate, Buprofezin, carbaryl, chloropropham, chloropyrifos, chloropyrifos, chlozolinate, cyfluthrin sum, DDD, DDE, DDT, deltamethrin, diazinon, dichlobenil, dichlofluanid, dicofol, dieldrin, diphenylamine, endosulfan, endosulfan sulphate, ethion, ethofumesat, etrimfos, flucythrinat, furalaxyl, HCB, HCH-beta, HCH-gamma, heptachlorepoxide (trans), methylkresoxim, malaoxon, malthion, mecarbam, metalaxyl, methidathion, metoxuron, myclobutanil, oxadixyl, oxychlordane, paclobutrazol, parathion ethyl, parathion methyl, penconazole, pendimethalin, pentachlorothioanisole, permethrin, phosmet, pirimiphosmethyl, prochloraz, procymidone, profenofos, prometryn, propargit, propham, propyzamide, chinalphos, chintozene, simazin, tecnazene, terbuthyl azine, tetradifon, vinclozolin.

The column packing materials according to the present invention also enable the detection of fluorescence-derivatized FQ-deoxynivalenol in wheat. To this end, ground wheat is mixed with 100 ml aqueous acetonitrile and the extract is filtered. For purification, 5 ml of the filtered extract are filled into an analytical tube according to U.S. Pat. No. 4,895,808, and the purification and drying of the sample are effected using a packing material for a micro adsorption column containing 1.5 g detergent mixture 2 and 1.5 g desiccant mixture 1 as well as a glass frit above and below the two layers comprised of detergent and desiccant. The sample is passed through the column packed with the column packing material, and 1 ml of the purified, dried extract is filled into a measuring vial, to which 1,2-diaminomethane in methanol and ZrO nitrate in methanol are added for derivatization. The closed vial is heated at 70° C. for 8 min. After quenching, the fluorescence of the sample is measured on a Perkin-Elmer fluorometer. It has been shown, also with this sample, that there are no more interfering impurities in the sample purified by using the tubes according to the present invention and that a derivatization can be carried out immediately after purification without any further, preceding purification or preparation.

To sum up, all of the methods in which the column packing materials according to the invention are used have in common that they provide enormous gains in time over the methods according to the prior art, the time involved in the purification and drying of the respective samples, in particular, amounting to a maximum of 1.5 to 2 min, which is many times shorter than the conventional methods according to the prior art, and, at the same time, yield extremely pure and dry products.

1. A packing material for a micro-adsorption column for drying and/or purifying dissolved organic or biological analytes such as toxins, antibiotics, vitamins, hormones, pesticides and the like, containing at least one desiccant, wherein the column packing material contains magnesium sulphate and at least one further desiccant selected from the group comprising aluminium oxide, calcium chloride, calcium hydride, calcium oxide, calcium sulphate, potassium hydride, silica gel, copper sulphate, magnesium oxide, magnesium perchlorate, molecular sieves, sodium hydroxide, phosphorus pentoxide, sulphuric acid on silicate, phosphorus pentoxide on silicate, as well as 0.5 to 90 wt. % of a naturally occurring or synthetic carrier with a large internal surface area, such as zeolites, diatomaceous earths, bentonite, silicon dioxide or the like.

2. The packing material for a micro-adsorption column according to claim 1, wherein the packing material for a micro-adsorption column contains 5 to 70 wt. % carrier.

3. The packing material for a micro-adsorption column according to claim 1, wherein the packing material for a micro-adsorption column is comprised of 0.5 to 90 wt. % carrier, 20 to 60 wt. % magnesium sulphate, 20 to 60 wt. % potassium carbonate and 10 to 35 wt. % calcium chloride.

4. The packing material for a micro-adsorption column according to claim 1, wherein the packing material for a micro-adsorption column additionally contains at least one adsorbent or detergent selected from the group comprising cyclic, linear or branched C₈ or C₁₈ hydrocarbons substituted with phenyl, cyclohexyl, butyl, ethyl, methyl, cyanopropyl, diol, carboxylate, benzenesulfoxylate, aminopropyl, primary, secondary, tertiary or quaternary amino residues or diethylamine; neutral, acidic or basic aluminium oxide, ion exchangers, silica gel, active carbon or magnesium silicate.

5. The packing material for a micro-adsorption column according to claim 1, wherein the packing material for a micro-adsorption column is used in the form of layers.

6. The packing material for a micro-adsorption column according to claim 1, wherein the packing material for a micro-adsorption column contains at least one purification or adsorption layer comprised of a mixture of 0.5 to 90 wt. % carrier, optionally silica gel, and at least one cyclic, linear or branched C₈ or C₁₈ hydrocarbon substituted with phenyl, cyclohexyl, butyl, ethyl, methyl, cyanopropyl, diol, carboxylate, benzenesulfoxylate, aminopropyl, primary, secondary, tertiary or quaternary amino residues or diethylamine, as well as at least one desiccant layer comprised of 0.5 to 90 wt. % carrier, the balance being desiccant.

7. The packing material for a micro-adsorption column according to claim 1, wherein the packing material for a micro-adsorption column contains at least one purification or adsorption layer comprised of a mixture of 0.5 to 90 wt. % and, in particular, 5 to 87 wt. % carrier, in particular a diatomaceous earth, 10 to 80 wt. % and, in particular, 25 to 50 wt. % aluminium oxide, 2 to 70 wt. % and, in particular, 8 to 35 wt. % ion exchanger, 10 to 95 wt. % and, in particular, 12 to 70 wt. % active carbon as well as 3 to 65 wt. % and, in particular, 10 to 40 wt. % of at least one cyclic, linear or branched C₈ or C₁₈ hydrocarbon substituted with phenyl, cyclohexyl, butyl, ethyl, methyl, cyanopropyl, diol, carboxylate, benzenesulfoxylate, aminopropyl, primary, secondary, tertiary or quaternary amino residues or diethylamine, as well as at least one desiccant layer comprised of 0.5 to 90 wt. % carrier, the balance being desiccant.

8. A micro-adsorption column for drying and/or purifying dissolved organic or biological analytes such as toxins, antibiotics, vitamins, hormones, pesticides and the like, containing at least one desiccant, wherein said column is packed with magnesium sulphate and at least one further desiccant selected from the group comprising aluminium oxide, calcium chloride, calcium hydride, calcium oxide, calcium sulphate, potassium hydride, silica gel, copper sulphate, magnesium oxide, magnesium perchlorate, molecular sieves, sodium hydroxide, phosphorus pentoxide, sulphuric acid on silicate, phosphorus pentoxide on silicate, as well as 0.5 to 90 wt. % of a naturally occurring or synthetic carrier with a large internal surface area, such as zeolites, diatomaceous earths, bentonite, silicon dioxide or the like.

9. A The micro-adsorption column according to claim 8, wherein the column is packed with 5 to 70 wt. % carrier.

10. A The micro-adsorption column according to claim 8, wherein the column is packed with at least two layers.

11. The micro-adsorption column according to claim 8, wherein the column, on its feed end, outflow end and optionally between the layers, is each equipped with a filter layer selected from a frit, filter paper, membrane or diaphragm.

12. The micro-adsorption column according to claim 10, wherein at least one of the layers is a desiccant-containing layer and at least one of the layers is a detergent- or adsorbent-containing layer, the detergent or adsorbent being selected from the group comprising cyclic, linear or branched C₈ or C₁₈ hydrocarbons substituted with phenyl, cyclohexyl, butyl, ethyl, methyl, cyanopropyl, diol, carboxylate, benzenesulfoxylate, aminopropyl, primary, secondary, tertiary or quaternary amino residues or diethylamine; neutral, acidic or basic aluminium oxide, an ion exchanger, silica gel, active carbon or magnesium silicate.

13. A The micro-adsorption column according to claim 8, wherein the column is packed, from its feed end to its outflow end, with a first purification or adsorbent layer containing 0.5 to 90 wt. % carrier, silica gel as well as, optionally, aluminium oxide and/or an ion exchanger, a first desiccant layer comprised of 0.5 to 90 wt. % carrier, magnesium sulphate, as well as one or several further desiccants selected from the group of aluminium oxide, calcium chloride, calcium sulphate, potassium hydride, silica gel, copper sulphate, magnesium oxide, molecular sieves, sodium hydroxide, phosphorus pentoxide, sulphuric acid on silicate, phosphorus pentoxide on silicate, a second purification or adsorbent layer containing 0.5 to 90 wt. % carrier as well as at least one cyclic, linear or branched and substituted C₈ or C₁₈ hydrocarbon as well as optionally active carbon, and a second desiccant layer containing 0.5 to 90 wt. % carrier and a desiccant selected from calcium chloride, potassium carbonate, magnesium sulphate as well as optionally one or several further desiccants selected from the group comprising calcium chloride, calcium hydride, calcium oxide, calcium sulphate, potassium hydride, silica gel, magnesium oxide, magnesium perchlorate, sodium hydroxide, phosphorus pentoxide, sulphuric acid on silicate, phosphorus pentoxide on silicate.

14. The use of a packing material for a micro-adsorption column according to claim 1, for drying and/or purifying dissolved organic or biological analytes such as toxins, antibiotics, vitamins, hormones, pesticides and the like, wherein the column packing material or column, respectively, is used for drying and/or purifying an aqueous organic solution having a water content of up to 30 wt. % of the organic or biological analytes.

15. The use of a packing material for a micro-adsorption column according to claim 14, wherein the ratio of the micro-adsorption column packing material to the analyte solution to be treated is at least 2:1 to 1:5 and, in particular, 1.5:1 to 1:2.5.

16. The use of a packing material for a micro adsorption column according to claim 8, for drying and/or purifying dissolved organic or biological analytes such as toxins, antibiotics, vitamins, hormones, pesticides and the like, wherein the column packing material or column, respectively, is used for drying and/or purifying an aqueous organic solution having a water content of up to 30 wt. % of the organic or biological analytes.
